(19) United States
(12) Patent Application Publication
(10) Pub. No.: US 2026/0313409 A1
(43) Pub. Date: Oct. 8, 2026

(54) DMG/EDMG SENSING METHOD AND SYSTEM FOR REPORTING MULTIPLE SENSING RESULTS VIA ONE MEASUREMENT SETUP

(71) Applicant: SHENZHEN TCL NEW TECHNOLOGY CO., LTD., Shenzhen, Guangdong (CN)

(72) Inventor: Zhanjing BAO, Shenzhen, Guangdong (CN)

(73) Assignee: SHENZHEN TCL NEW TECHNOLOGY CO., LTD., Shenzhen, Guangdong (CN)

(21) Appl. No.: 19/483,606

(22) PCT Filed: May 12, 2023
(86) PCT No.: PCT/CN2023/093941

§ 371 Date: Nov. 11, 2025

(51) Int. Cl. H04W 24/08; H04W 84/12

(52) U.S. Cl. CPC H04W 24/08; H04W 84/12

(57) ABSTRACT

A wireless local area network (WLAN) sensing method and a WLAN system are disclosed. The WLAM system includes one or more first stations (STAs), a second STA, and/or one or more third STAs. The WLAN sensing method includes reporting, by the one or more first STAs, multiple types of measurement results to the second STA and/or the one or more third STAs through one measurement setup, wherein the measurement results and the measurement setup are associated with a directional multi gigabit (DMG)/enhanced DMG (EDMG) sensing.

### TECHNICAL FIELD

The present disclosure relates to the field of communication systems, and more particularly, to a wireless local area network (WLAN) sensing method and a WLAN system, for example, for DMG/EDMG sensing method and system for reporting multiple sensing results via one measurement setup.

### BACKGROUND OF DISCLOSURE

In recent years, Integrated Sensing and Communication (ISAC) has become a popular academic research direction of wireless communication and may become one of the most core features in future wireless communication systems. Communication and sensing have developed independently as two technological fields for a long time. However, from the current technological trends, sensing systems represented by radar are increasingly similar to communication systems represented by wireless communication network in terms of system architecture, channel characteristics, and signal processing. On the other hand, from the perspective of scenario requirements, various emerging application scenarios, including the Internet of Things, the Internet of Vehicles, smart homes, smart cities, etc., require joint design of communication and sensing functions.

In the standardization process of ISAC, IEEE took the lead in establishing the industry's first international standard for ISAC: IEEE 802.11bf (WLAN sensing). Task Group bf is expected to develop an amendment that defines modifications to the IEEE 802.11 medium access control layer (MAC) and to the Directional Multi Gigabit (DMG) and enhanced DMG (EDMG) physical layers (PHYs) to enhance Wireless Local Area Network (WLAN) sensing (SENS) operation in license-exempt frequency bands between 1 GHz and 7.125 GHz and above 45 GHz. In scenarios that require high precision and security, millimeter wave sensing is a crucial capability for WLAN sensing. Relying on millimeter wave sensing, precise measurement of target Doppler information can be achieved.

Sensing tasks often require monitoring the multidimensional information of sensing targets, such as position, displacement, direction, phase, altitude, etc. If the current DMG/EDMG sensing process is adopted, multiple measurements and reports between devices are required to obtain multiple types of measurement results, which cannot report all the required information at once. In practical applications, this can cause high delay and channel overhead in current DMG/EDMG sensing, which may affect the original WLAN communication traffic.

Moreover, during the measurement process, the sensing requirements may change, but a sensing responder (SR) always follows the reporting rules initially agreed with a sensing initiator (SI), which may result in the reported results not being able to adapt to the new sensing requirements and require re-sensing, further reducing sensing efficiency.

Therefore, there is a need for a wireless local area network (WLAN) sensing method and a WLAN system, which can solve issues in the prior art.

### SUMMARY

An object of the present disclosure is to propose a wireless local area network (WLAN) sensing method and a WLAN system, which can solve issues in the prior art, provide low latency and low channel overhead, and/or provide high flexibility and reliability.

In a first aspect of the present disclosure, a wireless local area network (WLAN) sensing method by a WLAN system is disclosed. The WLAN system comprises one or more first stations (STAs), a second STA, and/or one or more third STAs, and the WLAN sensing method comprises: reporting, by the one or more first STAs, multiple types of measurement results to the second STA and/or the one or more third STAs through one measurement setup, wherein the measurement results and the measurement setup are associated with a directional multi gigabit (DMG)/enhanced DMG (EDMG) sensing.

In a second aspect of the present disclosure, a WLAN system comprises one or more first STAs, a second STA, and/or one or more third STAs, wherein the one or more first STAs, the second STA, and/or the one or more third STAs are configured to execute the above method.

In a third aspect of the present disclosure, a non-transitory machine-readable storage medium has stored thereon instructions that, when executed by a computer, cause the computer to perform the above method.

In a fourth aspect of the present disclosure, a chip includes a processor, configured to call and run a computer program stored in a memory, to cause a device in which the chip is installed to execute the above method.

In a fifth aspect of the present disclosure, a computer readable storage medium, in which a computer program is stored, causes a computer to execute the above method.

In a sixth aspect of the present disclosure, a computer program product includes a computer program, and the computer program causes a computer to execute the above method.

In a seventh aspect of the present disclosure, a computer program causes a computer to execute the above method.

Some embodiments of the present disclosure propose a DMG/EDMG sensing method and a system that can report multiple type of measurement results through one measurement setup and can be reported to different STAs according to sensing task requirements. In addition, real-time updates and verification of the reporting type and addressing can be achieved through pre reporting polling, which not only reduces the latency and channel overhead of DMG/EDMG sensing, but also improves the flexibility and reliability of the reporting phase.

Invention effects of some embodiments of the present disclosure may provide low latency and low channel overhead: Report multiple different types of measurement results with just one configuration/setup; and/or high flexibility and reliability: Confirm or modify the report result type and addressing through poll frames before reporting.

Further overall solution of some embodiments of the present disclosure is as follows.

1. SI and SR negotiate sensing configuration. During this stage, SI may send a DMG/EDMG sensing measurement setup request frame to SR, which may transmit parameters related to sensing setup. Specifically, the report setup control field in this frame may contain parameters related to reporting such as a reporting type, a receiver (RX) address/beamlist, and/or an interval parameter.

2. SR responds to the request frame by sending the DMG/EDMG Sensing measurement setup response frame to SI. The feedback information of SR may be transmitted in this frame, and there are three situations:

a) Feedback ‘SUCCESS’ indicates that SR accepts all sensing setup parameters from SI, and once negotiation is completed, SR may start measurement.

b) Feedback ‘SUGGESTED’_CHANGES' indicates that SR has proposed modification values for one or more parameters. SI may update the configuration parameters based on SR's suggested values and resend the request frame to SR. SI receives the updated parameters and sends a response frame containing ‘SUCCESS’ to SI. The negotiation stage is completed, and SR may start measurement.

c) The feedback ‘DECLINE’ indicates that SR refuses to negotiate the sensing setup and may not participate in this sensing task.

3. In one or more measurement bursts, SR performs sounding based on sensing setup parameters.

4. After completing the sounding, SR reports measurement results to SI in two ways:

a) SI sends a report polling frame to SR, which contains a report element. This element field may confirm or modify the report type, RX address/beamlist, an interval parameter, and/or other related parameters. SR may report based on the received polling frame instructions, that is, SR may wait until receiving the report polling frame before sending the report frame to SI, and the report frame may transmit the measurement results.

b) SR does not need to wait for the report polling frame. Based on the confirmed reporting parameters during the negotiation stage, SR directly sends the report frame to SI after the detection is completed, and the report frame may transmit the measurement results.

5. The sensing process terminates in three ways:

a) Explicit way: SI actively sends DMG/EDMG sensing termination frame to SR to stop sensing.

b) Implicit way 1: During the sensing negotiation stage, both SI and SR agree to terminate sensing by default after SR sends the report frame for a period of time.

c) Implicit way 2: SR cannot successfully complete the report after a certain period of time, and the sensing process is timed out and terminated.

The key point of an example of the present disclosure lies in the innovation of the structure of the setup request frame and polling frame transmitted during the DMG/EDMG sensing negotiation stage and DMG/EDMG sensing report stage.

Frame structure 1:

Design the “report setup control” field in the DMG/EDMG sensing setup request frame.

The report setup control field is used to transmit the set parameters related to reporting. To ensure the flexibility of the report stage, the control report setup control field contains a required subfield (a report requested/needed subfield) and 4 optional subfields (a report multi-type subfield, a report type subfield, an RX address/beamlist subfield, and a report interval subfield are 4 optional subfields). The purpose of each subfield is as follows:

1) Report requested/needed subfield: The report requested/needed subfield indicates whether SR (such as one or more first STAs) needs to report measurement results to SI (such as second STA) or other SRs (such as one or more third STAs). Setting the report requested/needed subfield to a first value such as 1 indicates that reporting is required, and the report multi type subfield becomes a mandatory subfield; if set the report requested/needed subfield to a second value such as 0, it means there is no need to report, and the other four subfields will not exist (there are none of the report multi-type subfield, the report type subfield, the RX address/beamlist subfield, and the report interval subfield).

2) Report multi-type subfield: The report multi-type subfield indicates whether SR (such as one or more first STAs) needs to report multiple different types of measurement results to SI (such as second STA) or other SRs (such as one or more third STAs). Setting the report multi-type subfield to a first value such as 1 indicates that multiple results need to be reported, and the “report interval”, “report type”, and “RX address/beamlist” subfields become mandatory subfields; setting the report multi-type subfield to a second value such as 0 means that only one type of measurement result may be reported, and the report type becomes a required subfield, while the other two subfields will not exist (there are none of the RX address/beamlist subfield and the report interval subfield).

3) Report type subfield: The report type subfield indicates the type of results that need to be reported.

4) RX address/beamlist subfield is the sending address corresponding to different report results, and the order of report results is mapped to address.

5) Report interval subfield: The report interval subfield indicates the time interval between different types of reports sent by a STA as TX (transmitter) among SR devices. SI (such as second STA) and other STAs that may serve as RX (receiver) decode and verify different types of reported results separately to obtain various measurement results.

Correspondingly, the report element field in the report polling frame during the reporting phase is designed.

Report change request subfield: The report change request subfield indicates whether the SI (such as second STA) needs to modify the reporting related parameters set during the negotiation stage. Set to a first value such as 1: The reporting parameters need to be modified, and the modified parameters may be transmitted in the other corresponding subfields; Set to a second value such as 0: Keep the reported parameters unchanged from the setup request frame, and the other four subfields are no longer needed (there are none of the report multi-type subfield, the report type subfield, the RX address/beamlist subfield, and the report interval subfield).

### Frame Structure 2:

Design the “report setup control” field in the DMG/EDMG sensing setup request frame.

Report aggregation type subfield: The report aggregation type subfield indicates whether the reported results are greater than one, and multiple reported results may be reported within one aggregation frame. Setting the report aggregation type subfield to a first value such as 1 indicates that the type of reported results is greater than or equal to 2, and the results should be reported in an aggregated manner; Set the report aggregation type subfield to a second value such as 0, which means only one result needs to be reported.

The remaining subfields are similar to those in frame structure 1 and will not be further elaborated here. There is no report interval field, which supports TX STA to aggregate and report different reported results. After RX STAs receives the aggregated results, they complete decoding and verification at once, and obtain multiple measurement results.

Correspondingly, the report element field in the report polling frame during the reporting phase is designed.

Similarly, the report change request is a mandatory field, and the remaining three fields (the report aggregation type subfield, the report type subfield, and the RX address/beamlist subfield) are determined based on whether their corresponding information needs to be modified or not.

Whether in frame structure 1 or frame structure 2, the design of the report element field in the polling frame can further modify the reporting interval, type, and other related parameters during the reporting phase, increasing the flexibility of the reporting phase. If the reporting type requirement changes at this time and the original multiple types are no longer needed, the SR (such as one or more first STAs) can be notified directly in the polling frame without the need for the SR (such as one or more first STAs) to report according to the original setup, further saving link resources and improving sensing efficiency.

### Transmission Method for Reporting Types

In some examples, due to the fact that DMG/EDMG sensing can report more types of results after measurement compared to sub-7 GHz-based sensing, an index table called “report type table” is used between SI (such as second STA) and SR (such as one or more first STAs or third STAs) to represent the types of results that need to be reported. The index value is used to represent different result types in the table. The report type field in the DMG/EDMG sensing setup request frame only needs to pass the index value to indicate which result types need to be reported by SR. As shown in the following table, 0-9 represents 10 different result types, and 10-255 is a reserved index value. If a new report type is generated, a number can be selected from 10 to 255 to represent it. Obviously, carrying a value of 156 in the report type field means that the results need to be reported are CSI, DMG/EDMG sending image Doppler-direction, and DMG/EDMG sending image range-Doppler direction. If carrying a value of 3 in this field, it means that only DMG/EDMG sending image range-Doppler needs to be reported.

TABLE 1
Report type table

| Value | Description |
|---|---|
| 0 | No report |
| 1 | CSI |
| 2 | DMG/EDMG Sensing Image Direction |
| 3 | DMG/EDMG Sensing Image Range-Doppler |
| 4 | DMG/EDMG Sensing Image Range-Direction |
| 5 | DMG/EDMG Sensing Image Doppler- |
| | Direction |
| 6 | DMG/EDMG Sensing Image Range-Doppler |
| | Direction |
| 7 | Target |
| 8 | DMG/EDMG Sensing Image Doppler-phase |
| 9 | DMG/EDMG Sensing Image Range-Doppler |
| | phase |
| 10-255 | Reserved |

### BRIEF DESCRIPTION OF DRAWINGS

In order to illustrate the embodiments of the present disclosure or related art more clearly, the following figures will be described in the embodiments are briefly introduced. It is obvious that the drawings are merely some embodiments of the present disclosure, a person having ordinary skill in this field can obtain other figures according to these figures without paying the premise.

FIG. 1 is a schematic diagram illustrating an example of a WLAN system according to an embodiment of the present disclosure.

FIG. 2 is a block diagram illustrating an example of a WLAN system according to an embodiment of the present disclosure.

FIG. 3 is a flowchart illustrating a WLAN sensing method performed by a WLAN system according to an embodiment of the present disclosure.

FIG. 4 is a schematic diagram illustrating an example of a DMG/EDMG sensing procedure according to an embodiment of the present disclosure.

FIG. 5 is a schematic diagram illustrating an example of a frame structure of sensing measurement setup request frame according to an embodiment of the present disclosure.

FIG. 6 is a schematic diagram illustrating an example of a frame structure of report polling frame according to an embodiment of the present disclosure.

FIG. 7 is a schematic diagram illustrating an example of a frame structure of sensing measurement setup request frame according to an embodiment of the present disclosure.

FIG. 8 is a schematic diagram illustrating an example of a frame structure of report polling frame according to an embodiment of the present disclosure.

FIG. 9A is a schematic diagram illustrating an example of a sequential coordinated monostatic DMG/EDMG sensing according to an embodiment of the present disclosure.

FIG. 9B is a schematic diagram illustrating an example of a frame format according to an embodiment of the present disclosure.

FIG. 9C is a schematic diagram illustrating an example of a frame format according to an embodiment of the present disclosure.

FIG. 10A is a schematic diagram illustrating an example of a parallel coordinated monostatic DMG/EDMG sensing according to an embodiment of the present disclosure.

FIG. 10B is a schematic diagram illustrating an example of a frame format according to an embodiment of the present disclosure.

FIG. 10C is a schematic diagram illustrating an example of a frame format according to an embodiment of the present disclosure.

FIG. 10D is a schematic diagram illustrating an example of a frame format according to an embodiment of the present disclosure.

FIG. 11A is a schematic diagram illustrating an example of a multistatic DMG/EDMG sensing according to an embodiment of the present disclosure.

FIG. 11B is a schematic diagram illustrating an example of a frame format according to an embodiment of the present disclosure.

FIG. 11C is a schematic diagram illustrating an example of a frame format according to an embodiment of the present disclosure.

FIG. 12 is a block diagram of a system for wireless communication according to an embodiment of the present disclosure.

### DETAILED DESCRIPTION OF EMBODIMENTS

Embodiments of the present disclosure are described in detail with the technical matters, structural features, achieved objects, and effects with reference to the accompanying drawings as follows. Specifically, the terminologies in the embodiments of the present disclosure are merely for describing the purpose of the certain embodiment, but not to limit the disclosure.

In this disclosure, the term “/” can be interpreted to indicate “and/or.”

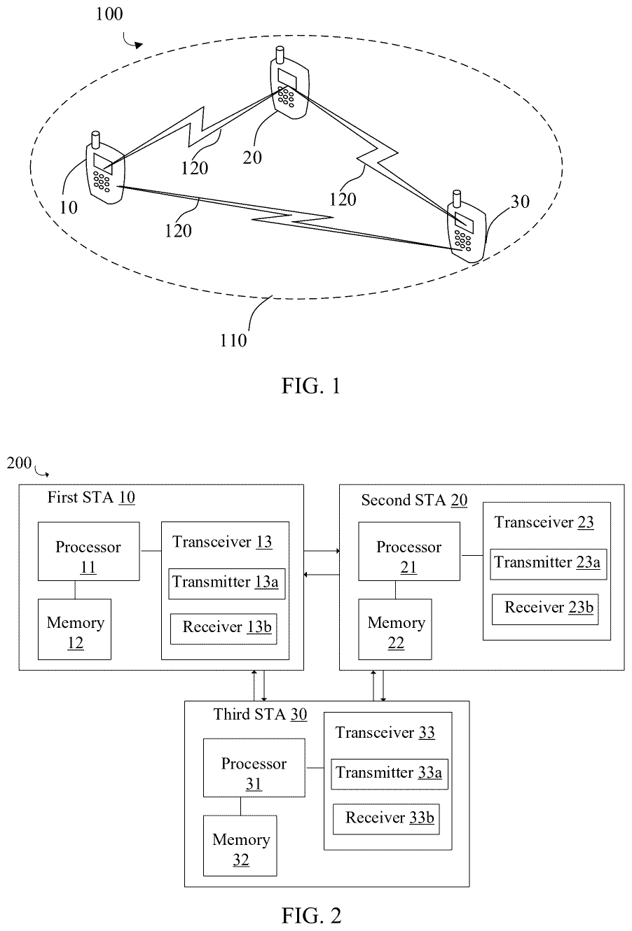

FIG. 1 illustrates an example of a WLAN system 100 according to an embodiment of the present disclosure. The WLAN system 100 may be an example of a Wi-Fi network configured in accordance with various aspects of the present disclosure. The WLAN system 100 may include one or more first STAs 10, a second STA 20, and/or one or more third STAs 30, which may represent devices such as mobile stations, personal digital assistant (PDAs), other handheld devices, netbooks, notebook computers, tablet computers, laptops, display devices (such as TVs, computer monitors, etc.), printers, etc. The one or more first APs 10 and the one or more third STAs 30 may represent sensing responders (SRs). The second STA 20 may represent a sensing initiator (SI). The one or more first STAs 10, the second STA 20, and the one or more third STAs 30 in the network can communicate with one another through direct wireless links 120. Also illustrated is a coverage area 110, which may represent a service area of the WLAN system 100.

FIG. 2 illustrates an example of a WLAN system 200 according to an embodiment of the present disclosure. FIG. 2 illustrates that, the WLAN system 100 may include one or more first STAs 10, a second STA 20, and/or one or more third STAs 30. The first STA 10 may include a memory 12, a transceiver 13, and a processor 11 coupled to the memory 12 and the transceiver 13. The transceiver 13 may include a transmitter 13a and a receiver 13b. The second STA 20 may include a memory 22, a transceiver 23, and a processor 21 coupled to the memory 22 and the transceiver 23. The transceiver 23 may include a transmitter 23a and a receiver 23b. The third STA 30 may include a memory 32, a transceiver 33, and a processor 31 coupled to the memory 32 and the transceiver 33. The transceiver 33 may include a transmitter 33a and a receiver 33b. The processor 11, 21 or 31 maybe configured to implement proposed functions, procedures and/or methods described in this description. Layers of radio interface protocol may be implemented in the processor 11, 21 or 31. The memory 12, 22 or 32 is operatively coupled with the processor 11, 21 or 31 and stores a variety of information to operate the processor 11, 21 or 31. The transceiver 13, 23 or 33 is operatively coupled with the processor 11, 21 or 31, and the transceiver 13, 23 or 33 transmits and/or receives a radio signal.

The processor 11, 21 or 31 may include application-specific integrated circuit (ASIC), other chipset, logic circuit and/or data processing device. The memory 12, 22 or 32 may include read-only memory (ROM), random access memory (RAM), flash memory, memory card, storage medium and/or other storage device. The transceiver 13, 23 or 33 may include baseband circuitry to process radio frequency signals. When the embodiments are implemented in software, the techniques described herein can be implemented with modules (e.g., procedures, functions, and so on) that perform the functions described herein. The modules can be stored in the memory 12, 22 or 32 and executed by the processor 11, 21 or 31. The memory 12, 22 or 32 can be implemented within the processor 11, 21 or 31 or external to the processor 11, 21 or 31 in which case those can be communicatively coupled to the processor 11, 21 or 31 via various means as is known in the art.

FIG. 3 illustrates a WLAN sensing method 300 performed by a WLAN system (such as the WLAN system 100 or the WLAN system 200) according to an embodiment of the present disclosure. In some embodiments, the WLAN sensing method 300 includes: an operation 302, reporting, by the one or more first STAs, multiple types of measurement results to the second STA and/or the one or more third STAs through one measurement setup, wherein the measurement results and the measurement setup are associated with a directional multi gigabit (DMG)/enhanced DMG (EDMG) sensing. The one or more STAs 10, the second STA 20, and/or the one or more third STAs 30 are configured to execute the method in the following some embodiments.

Some examples of the present disclosure propose a DMG/EDMG sensing method and a WLAN system that can report multiple types of measurement results through one measurement setup. This can provide low latency and low channel overhead by reporting multiple different types of measurement results with just one configuration/setup. Compared to the current technology, the measurement framework of 802.11bf includes the directional multi-gigabit (DMG)/EDMG sensing procedure, which completes a sensing task and reports one type of measurement results through one measurement setup. In the current technology, if the sensing task requires multidimensional information of the target, multiple measurement settings, as well as multiple measurements and reports, are required, resulting in high measurement latency and link overhead.

Further, compared to the current technology, the IEEE 802.11bf standard working group has developed a workflow for DMG/EDMG sensing including DMG/EDMG sensing session setup, DMG/EDMG measurement setup, one or more DMG/EDMG sensing bursts, DMG/EDMG measurement setup termination, and session termination. During the current process, the DMG/EDMG sensing measurement setup is a procedure that allows a sensing initiator (SI) and a sensing responder (SR) to exchange and agree on operational parameters associated with DMG/EDMG sensing bursts and DMG/EDMG sensing instances. A DMG/EDMG sensing measurement setup starts with the SI (sensing initiator) sending a sensing measurement setup request frame to the SR (sensing responder). The sensing measurement setup request frame will contain various information related to DMG/EDMG sensing, one of which may indicate the reporting type. The sensing measurement setup request frame may contain various parameters related to perception, one of which may indicate the reporting type. That is, during the current measurement setup stage, SI may negotiate the reporting type with SR, and only one result can be reported at one time, which may cause significant link overhead in practical applications. Some examples of the present disclosure can solve issues in the prior art by reporting multiple different types of measurement results with just one configuration/setup.

In some examples, the DMG)/EDMG sensing may be millimeter wave sensing. Unlike sensing in the sub-7 GHz frequency band, millimeter wave sensing can provide multi-dimensional information of the target object, including range, Doppler (direction, phase), Azimuth, Elevation, etc. This is crucial for scenarios such as small displacement detection and small object recognition.

Use cases rely on millimeter waves in WLAN sensing related application scenarios are disclosed. Within a certain range, millimeter wave sensing can achieve millimeter level ranging accuracy, with an angle measurement error of less than ±5 degrees and has both accuracy and robustness. However, Doppler measurement in the millimeter wave frequency band requires devices to perform sounding for a long time, and the channel overhead occupied by one measurement is high, around 10%. If multiple measurements are performed, it may affect other Wi-Fi services.

The use cases include at least one of the followings: 1. Audio with user tracking: Tracking persons in a room and pointing the sound of an audio system at those people. 2. Gesture recognition—short range (finger movement): Identification of a gesture from a set of gestures range less than 0.5 m. 3. Gesture recognition—medium range (hand movement): Identification of a gesture from a set of gestures range greater than 0.5 m. 4. A liveliness detection: Determination whether a close by object is alive or not. 5. Face/Body Recognition: Selection of the identity of a person from a set of known persons. 6. Sneeze sensing: Detecting and localizing the target human and sneeze droplet volume. 7. 3D vision: Building a 3D picture of an environment using multiple STAs. 8. In car sensing: Driver sleepiness detection/detection aid.

In some embodiments, reporting, by the one or more first STAs 10, the types of the measurement results to the second STA 20 and/or the one or more third STAs 30 through the one measurement setup is based on multiple sensing task requirements. This can provide low latency and low channel overhead, such that multiple different types of measurement results are reported with just one configuration/setup. The sensing task requirements my include an audio with user tracking, a gesture recognition—short range (finger movement), a gesture recognition—medium range (hand movement), a liveliness detection, a face/body recognition, a sneeze sensing, a 3D vision, and a in car sensing.

In some embodiments, the WLAN sensing method further includes determining, by the one or more first STAs 10, a real-time update, a verification of a reporting type, and/or an addressing of the measurement setup and/or the measurement results through a report polling frame. Therefore, real-time updates and verification of the reporting type and addressing can be achieved through pre reporting polling, which not only reduces the latency and channel overhead of DMG/EDMG sensing, but also improves the flexibility and reliability of the reporting phase. Further, this can provide high flexibility and reliability: Confirm or modify the report result type and addressing through poll frames before reporting.

In some embodiments, reporting, by the one or more first STAs 10, the types of the measurement results to the second STA 20 and/or the one or more third STAs 30 through the one measurement setup further comprises at least one of the following operations: a DMG/EDMG sensing negotiation, one or more DMG/EDMG measurement bursts, one or more DMG/EDMG measurement reports, and/or a DMG/EDMG sensing termination.

In some examples, the types of the DMG/EDMG sensing may include monostatic, bistatic, multistatic, monostatic sensing with coordination, and bistatic sensing with coordination. Monostatic sensing with coordination is an extension of monostatic to coordinate monostatic devices. Bistatic sensing with coordination is an extension of bistatic type to coordinate multiple sensing responders by one sensing initiator. In some examples, the DMG/EDMG sensing procedure may define the behavior of a single sensing initiator (SI) with one or more sensing responders (SRs). The SI is such as the second STA 20. The one or more SRs are the one or more first STAs or the one or more third STAs.

The DMG/EDMG sensing procedure is composed of one or more of the following: a DMG/EDMG sensing negotiation, one or more DMG/EDMG measurement bursts, one or more DMG/EDMG measurement reports, and a DMG/EDMG sensing termination. The DMG/EDMG measurement burst may comprise multiple DMG/EDMG sensing instances. One sensing responder may participate in multiple DMG/EDMG measurement bursts and DMG/EDMG sensing instances. A sensing initiator may maintain multiple sensing responders in multiple DMG/EDMG measurement bursts and DMG/EDMG sensing instances. A sensing initiator may indicate the sensing responder in the sensing receiver role or in the sensing receiver and sensing transmitter role to report at the DMG/EDMG sensing instance, and/or it may indicate the sensing responder to accumulate the results.

In some embodiments, the DMG/EDMG sensing negotiation further comprises the one or more first STAs 10 receiving a sensing measurement setup request frame form the second STA 20. The sensing measurement setup request frame may transmit parameters related to sensing setup. Specifically, the report setup control field in the sensing measurement setup request frame may contain parameters related to reporting such as a reporting type, a receiver (RX) address/beamlist, and/or an interval parameter. In some embodiments, the sensing measurement setup request frame comprises a report setup control field containing sensing setup parameters related to the measurement report. In some embodiments, the sensing setup parameters related to the measurement report comprise a reporting type, a receiver (RX) address/beamlist, and/or an interval parameter. This can provide an efficient DMG/EDMG sensing setup.

In some embodiments, the DMG/EDMG sensing negotiation further comprises the one or more first STAs 10 transmitting a sensing measurement setup response frame to the second STA 20 to response to the sensing measurement setup request frame. The feedback information of the one or more first STAs 10 may be transmitted in the sensing measurement setup response frame. This can provide an efficient DMG/EDMG sensing setup and report method.

In some embodiments, the one or more first STAs response a success feedback information through the sensing measurement setup response frame, and the success feedback information indicates that sensing setup parameters from the second STA are accepted by the one or more first STAs, and when the DMG/EDMG sensing negotiation is completed, the one or more first STAs start measuring. This can provide an efficient DMG/EDMG sensing setup and report method.

In some embodiments, the one or more first STAs response a suggested change feedback information through the sensing measurement setup response frame, and the suggested change feedback information indicates that the one or more first STAs provide modification values for the sensing setup parameters. In some embodiments, the sensing setup parameters are updated by the second STA based on the modification values, and/or the one or more first STAs are configured to receive an updated sensing measurement setup request frame comprising updated sensing setup parameters based on the modification values. In some embodiments, the one or more first STAs are configured to transmit an updated sensing measurement setup response frame to the second STA, the updated sensing measurement setup response frame comprises a success feedback information, and the success feedback information indicates that the updated sensing setup parameters from the second STA are accepted by the one or more first STAs, and when the DMG/EDMG sensing negotiation is completed, the one or more first STAs start measuring. This can provide an efficient DMG/EDMG sensing setup and report method.

In some embodiments, the one or more first STAs respond a decline feedback information through the sensing measurement setup response frame, and the decline feedback information indicates that the one or more first STAs refuse to negotiate a current sensing setup and/or has no participation in a current sensing task. This can provide an efficient DMG/EDMG sensing setup and report method.

In some embodiments, in the one or more DMG/EDMG measurement bursts, the one or more first STAs are configured to perform sounding based on sensing setup parameters. In some embodiments, after the one or more first STAs perform sounding, the one or more first STAs transmit the DMG/EDMG measurement report comprising the multiple types of measurement results to the second STA and/or the one or more third STAs. In some embodiments, the one or more first STAs transmitting the DMG/EDMG measurement report to the second STA and/or the one or more third STAs comprise that: the one or more first STAs are configured to receive a report polling frame from the second STA, and the one or more first STAs are configured to transmit a report frame comprising the multiple types of measurement results to the second STA and/or the one or more third STAs; or the one or more first STAs are configured to transmit the report frame comprising the multiple types of measurement results to the second STA and/or the one or more third STAs. This can provide an efficient DMG/EDMG sensing setup and report method.

In some embodiments, the DMG/EDMG sensing termination comprises that: a DMG/EDMG sensing termination frame are transmitted by the one or more first STAs, the second STA, and/or the one or more third STAs to terminate sensing; in the DMG/EDMG sensing negotiation, an agreement is made by the one or more first STAs, the second STA, and/or the one or more third STAs, and the agreement agrees to terminate sensing by default after the one or more first STAs send the report frame for a period of time; or the one or more first STAs fail to complete the DMG/EDMG measurement report after a certain period of time, and/or a sensing process is timed out and terminated. This can provide an efficient DMG/EDMG sensing setup and report method.

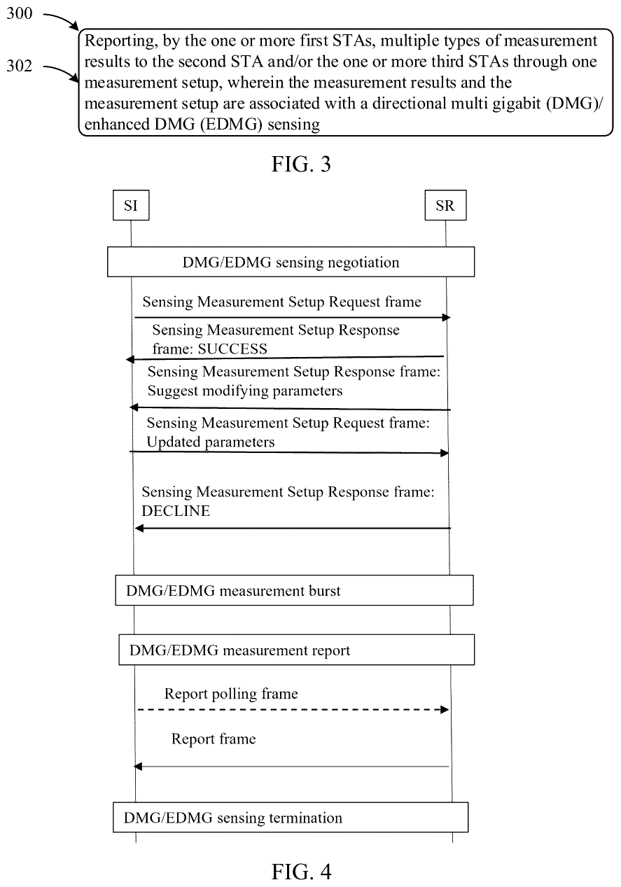

FIG. 4 is a schematic diagram illustrating an example of a DMG/EDMG sensing procedure according to an embodiment of the present disclosure. FIG. 4 illustrates that, in some embodiments, an overall process of the solution is as follows. This can provide an efficient DMG/EDMG sensing setup and report method.

1. SI and SR negotiate sensing configuration. During this stage, SI may send a DMG/EDMG sensing measurement setup request frame to SR, which may transmit parameters related to sensing setup. Specifically, the report setup control field in this frame may contain parameters related to reporting such as a reporting type, a receiver (RX) address/beamlist, and/or an interval parameter.

2. SR responds to the request frame by sending the DMG/EDMG sensing measurement setup response frame to SI. The feedback information of SR may be transmitted in this frame, and there are three situations:

a) Feedback ‘SUCCESS’ indicates that SR accepts all sensing setup parameters from SI, and once negotiation is completed, SR may start measurement.

b) Feedback ‘SUGGESTED’_CHANGES' indicates that SR has proposed modification values for one or more parameters. SI may update the configuration parameters based on SR's suggested values and resend the request frame to SR. SI receives the updated parameters and sends a response frame containing ‘SUCCESS’ to SI. The negotiation stage is completed, and SR may start measurement. In some embodiments, reporting, by the one or more first STAs 10, the types of the measurement results to the second STA 20 and/or the one or more third STAs 30 through the measurement setup further comprises a sequential coordinated monostatic DMG/EDMG sensing, a parallel coordinated monostatic DMG/EDMG sensing, or a multistatic DMG/EDMG sensing.

c) The feedback ‘DECLINE’ indicates that SR refuses to negotiate the sensing setup and may not participate in this sensing task.

3. In one or more measurement bursts, SR performs sounding based on sensing setup parameters.

4. After completing the sounding, SR reports measurement results to SI in two ways:

a) SI sends a report polling frame to SR, which contains a report element. This element field may confirm or modify the report type, RX address/beamlist, an interval parameter, and/or other related parameters. SR may report based on the received polling frame instructions, that is, SR may wait until receiving the report polling frame before sending the report frame to SI, and the report frame may transmit the measurement results.

b) SR does not need to wait for the report polling frame. Based on the confirmed reporting parameters during the negotiation stage, SR directly sends the report frame to SI after the detection is completed, and the report frame may transmit the measurement results.

5. The sensing process terminates in three ways:

a) Explicit way: SI actively sends DMG/EDMG sensing termination frame to SR to stop sensing.

b) Implicit way 1: During the sensing negotiation stage, both SI and SR agree to terminate sensing by default after SR sends the report frame for a period of time.

c) Implicit way 2: SR cannot successfully complete the report after a certain period of time, and the sensing process is timed out and terminated.

In some embodiments, the report setup control field of the sensing measurement setup request frame comprises a report requested/needed subfield and none or at least one of a report multi-type subfield, a report type subfield, an RX address/beamlist subfield, and a report interval subfield, and the report requested/needed subfield indicates whether the one or more first STAs need to report the measurement results to the second STA and/or the one or more third STAs. In some embodiments, if the report requested/needed subfield comprises a first value, the first value of the report requested/needed subfield indicates that reporting DMG/EDMG measurement results to the second STA and/or the one or more third STAs are required, and the report multi-type subfield is a mandatory subfield. In some embodiments, if the report requested/needed subfield comprises a second value, the second value of the report requested/needed subfield indicates that there is no need to report the DMG/EDMG measurement results to the second STA and/or the one or more third STAs, and the report setup control field of the sensing measurement setup request frame comprises none of the report multi-type subfield, the report type subfield, the RX address/beamlist subfield, and the report interval subfield. In some embodiments, the report multi-type subfield indicates whether the multiple types of measurement results need to be reported.

In some embodiments, if the report multi-type subfield comprises a first value, the first value of the report multi-type subfield indicates that reporting the multiple types of measurement results to the second STA and/or the one or more third STAs is required, and the report type subfield, the RX address/beamlist subfield, and the report interval subfield are mandatory subfields. In some embodiments, if the report multi-type subfield comprises a second value, the second value of the report multi-type subfield indicates that reporting only one type of measurement result to the second STA is required, and the report type subfield is a required subfield, and the report setup control field of the sensing measurement setup request frame comprises none of the RX address/beamlist subfield and the report interval subfield. In some embodiments, the report type subfield indicates the type of measurement results that needs to be reported, the RX address/beamlist subfield is a sending address corresponding to different report results, an order of report results is mapped to address, and the report interval subfield indicates a time interval between different types of reports.

In some embodiments, the report polling frame comprises a report element field. In some embodiments, the report element field comprises a report change request subfield and none or at least one of a report multi-type subfield, a report type subfield, an RX address/beamlist subfield, and a report interval subfield, and the report change request subfield indicates whether the measurement report relevant parameters need to be modified by the second STA in the DMG/EDMG sensing negotiation. In some embodiments, if the report change request subfield comprises a first value, reporting parameters need to be modified, and modified parameters are transmitted in the at least one of the report multi-type subfield, the report type subfield, the RX address/beamlist subfield, and the report interval subfield; if the report change request subfield comprises a second value, the reporting parameters are unchanged from the sensing measurement setup request frame, and the report element field comprises none of the report multi-type subfield, the report type subfield, the RX address/beamlist subfield, and the report interval subfield.

The key point of an example of the present disclosure lies in the innovation of the structure of the setup request frame and polling frame transmitted during the DMG/EDMG sensing negotiation stage and DMG/EDMG sensing report stage.

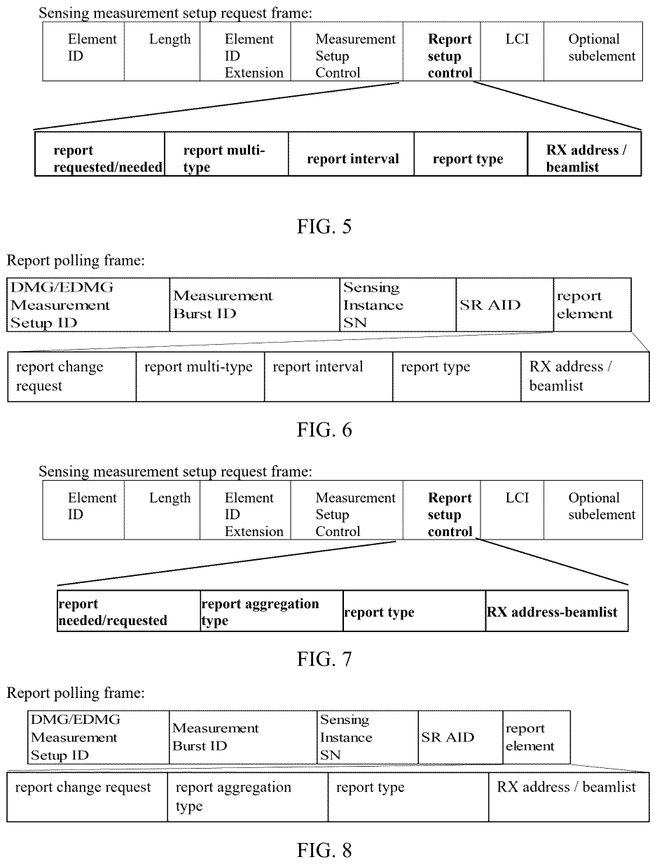

FIG. 5 and FIG. 6 illustrate an example of a frame structure (such as the following frame structure 1) according to an embodiment of the present disclosure. FIG. 5 illustrates an example of a frame structure of sensing measurement setup request frame. FIG. 6 illustrates an example of a frame structure of report polling frame.

### Frame Structure 1:

Design the “report setup control” field in the DMG/EDMG sensing setup request frame as illustrated in FIG. 5:

The report setup control field is used to transmit the set parameters related to reporting. To ensure the flexibility of the report stage, the control report setup control field contains a required subfield (a report requested/needed subfield) and 4 optional subfields (a report multi-type subfield, a report type subfield, an RX address/beamlist subfield, and a report interval subfield are 4 optional subfields), as illustrated in FIG. 5. The purpose of each subfield is as follows:

1) Report requested/needed subfield: The report requested/needed subfield indicates whether SR (such as one or more first STAs 10) needs to report measurement results to SI (such as second STA 20) or other SRs (such as one or more third STAs 30). Setting the report requested/needed subfield to a first value such as 1 indicates that reporting is required, and the report multi type subfield becomes a mandatory subfield; if set the report requested/needed subfield to a second value such as 0, it means there is no need to report, and the other four subfields will not exist (there are none of the report multi-type subfield, the report type subfield, the RX address/beamlist subfield, and the report interval subfield).

2) Report multi-type subfield: The report multi-type subfield indicates whether SR (such as one or more first STAs 10) needs to report multiple different types of measurement results to SI (such as second STA 20) or other SRs (such as one or more third STAs 30). Setting the report multi-type subfield to a first value such as 1 indicates that multiple results need to be reported, and the “report interval”, “report type”, and “RX address/beamlist” subfields become mandatory subfields; setting the report multi-type subfield to a second value such as 0 means that only one type of measurement result may be reported, and the report type becomes a required subfield, while the other two subfields will not exist (there are none of the RX address/beamlist subfield and the report interval subfield).

3) Report type subfield: The report type subfield indicates the type of results that need to be reported.

4) RX address/beamlist subfield is the sending address corresponding to different report results, and the order of report results is mapped to address.

5) Report interval subfield: The report interval subfield indicates the time interval between different types of reports sent by a STA as TX (transmitter) among SR devices. SI (such as second STA 20) and other STAs that may serve as RX (receiver) decode and verify different types of reported results separately to obtain various measurement results.

Correspondingly, the report element field in the report polling frame during the reporting phase is designed as illustrated in FIG. 6:

Report change request subfield: The report change request subfield indicates whether the SI (such as second STA 20) needs to modify the reporting related parameters set during the negotiation stage. Set to a first value such as 1: The reporting parameters need to be modified, and the modified parameters may be transmitted in the other corresponding subfields; Set to a second value such as 0: Keep the reported parameters unchanged from the setup request frame, and the other four subfields are no longer needed (there are none of the report multi-type subfield, the report type subfield, the RX address/beamlist subfield, and the report interval subfield).

In some embodiments, the report setup control field of the sensing measurement setup request frame comprises a report requested/needed subfield and none or at least one of a report aggregation type subfield, a report type subfield, and an RX address/beamlist subfield, and the report requested/needed subfield indicates whether the one or more first STAs need to report the measurement results to the second STA and/or the one or more third STAs. In some embodiments, if the report requested/needed subfield comprises a first value, the first value of the report requested/needed subfield indicates that reporting DMG/EDMG measurement results to the second STA and/or the one or more third STAs are required, and the report aggregation type subfield is a mandatory subfield. In some embodiments, if the report requested/needed subfield comprises a second value, the second value of the report requested/needed subfield indicates that there is no need to report the DMG/EDMG measurement results to the second STA and/or the one or more third STAs, and the report setup control field of the sensing measurement setup request frame comprises none of the report aggregation type subfield, the report type subfield, and the RX address/beamlist subfield.

In some embodiments, if the report aggregation type subfield comprises a first value, the first value of the report aggregation type subfield indicates that types of measurement results are greater than or equal to 2, and the types of measurement results are reported in an aggregated manner. In some embodiments, if the report aggregation type subfield comprises a second value, the second value of the report aggregation type subfield indicates that only one type of measurement result is reported. In some embodiments, a report element field comprises a report change request subfield and none or at least one of a report aggregation type subfield, a report type subfield, and an RX address/beamlist subfield, and the report change request subfield indicates whether the sensing up parameters are needed to be modified by the second STA in the DMG/EDMG sensing negotiation. In some embodiments, the report change request is a mandatory field, and an existence of the report aggregation type subfield, the report type subfield, and the RX address/beamlist subfield are determined based on whether their corresponding information needs to be modified or not.

FIG. 7 and FIG. 8 illustrate an example of a frame structure (such as the following frame structure 2) according to an embodiment of the present disclosure. FIG. 7 illustrates an example of a frame structure of sensing measurement setup request frame. FIG. 8 illustrates an example of a frame structure of report polling frame.

### Frame Structure 2:

Design the “report setup control” field in the DMG/EDMG sensing setup request frame as illustrated in FIG. 7:

Report aggregation type subfield: The report aggregation type subfield indicates whether the reported results are greater than one, and multiple reported results may be reported within one aggregation frame. Setting the report aggregation type subfield to a first value such as 1 indicates that the type of reported results is greater than or equal to 2, and the results should be reported in an aggregated manner; Set the report aggregation type subfield to a second value such as 0, which means only one result needs to be reported.

The remaining subfields are similar to those in frame structure 1 and will not be further elaborated here. There is no report interval field, which supports TX STA to aggregate and report different reported results. After RX STAs receives the aggregated results, they complete decoding and verification at once, and obtain multiple measurement results.

Correspondingly, the report element field in the report polling frame during the reporting phase is designed as illustrated in FIG. 8:

Similarly, the report change request is a mandatory field, and the remaining three fields (the report aggregation type subfield, the report type subfield, and the RX address/beamlist subfield) are determined based on whether their corresponding information needs to be modified or not.

Whether in frame structure 1 or frame structure 2, the design of the report element field in the polling frame can further modify the reporting interval, type, and other related parameters during the reporting phase, increasing the flexibility of the reporting phase. If the reporting type requirement changes at this time and the original multiple types are no longer needed, the SR (such as one or more first STAs 10) can be notified directly in the polling frame without the need for the SR (such as one or more first STAs 10) to report according to the original setup, further saving link resources and improving sensing efficiency.

In some embodiments, reporting, by the one or more first STAs 10, the types of the measurement results to the second STA 20 and/or the one or more third STAs 30 through the measurement setup is based on an index table, wherein the index table is used between the second STA 20 and the one or more first STAs 10 and/or the one or more third STAs 30. In some embodiments, the index table comprises one or more result types and/or one or more reserved index values. In some embodiments, the one or more result types comprise no report, CSI, DMG/EDMG sensing image direction, DMG/EDMG sensing image range-Doppler, DMG/EDMG sensing image range-direction, DMG/EDMG sensing image Doppler-direction, DMG/EDMG sensing image range-Doppler direction, target, DMG/EDMG sensing image Doppler-phase, and/or a DMG/EDMG sensing image range-Doppler phase.

In some examples, due to the fact that DMG/EDMG sensing can report more types of results after measurement compared to sub-7 GHz-based sensing, an index table called “report type table” is used between SI (such as second STA 20) and SR (such as one or more first STAs 10 or third STAs 30) to represent the types of results that need to be reported. The index value is used to represent different result types in the table. The report type field in the DMG/EDMG sensing setup request frame only needs to pass the index value to indicate which result types need to be reported by SR. As shown in the following table, 0-9 represents 10 different result types, and 10-255 is a reserved index value. If a new report type is generated, a number can be selected from 10 to 255 to represent it. Obviously, carrying a value of 156 in the report type field means that the results need to be reported are CSI, DMG/EDMG sending image Doppler-direction, and DMG/EDMG sending image range-Doppler direction. If carrying a value of 3 in this field, it means that only DMG/EDMG sending image range-Doppler needs to be reported.

TABLE 1
Report type table

| Value | Description |
|---|---|
| 0 | No report |
| 1 | CSI |
| 2 | DMG/EDMG Sensing Image Direction |
| 3 | DMG/EDMG Sensing Image Range-Doppler |
| 4 | DMG/EDMG Sensing Image Range-Direction |
| 5 | DMG/EDMG Sensing Image Doppler- |
| | Direction |
| 6 | DMG/EDMG Sensing Image Range-Doppler |
| | Direction |
| 7 | Target |
| 8 | DMG/EDMG Sensing Image Doppler-phase |
| 9 | DMG/EDMG Sensing Image Range-Doppler |
| | phase |
| 10-255 | Reserved |

Various embodiments are described. It is understood that the present disclosure is not limited in any way to the embodiments that are represented in the description and the drawings. Many variations and combinations of embodiments are possible within the framework of the present disclosure. Combinations of one or more aspects of the embodiments or combinations of different embodiments are possible within the framework of the present disclosure. All comparable variations are understood to fall within the framework of the present disclosure.

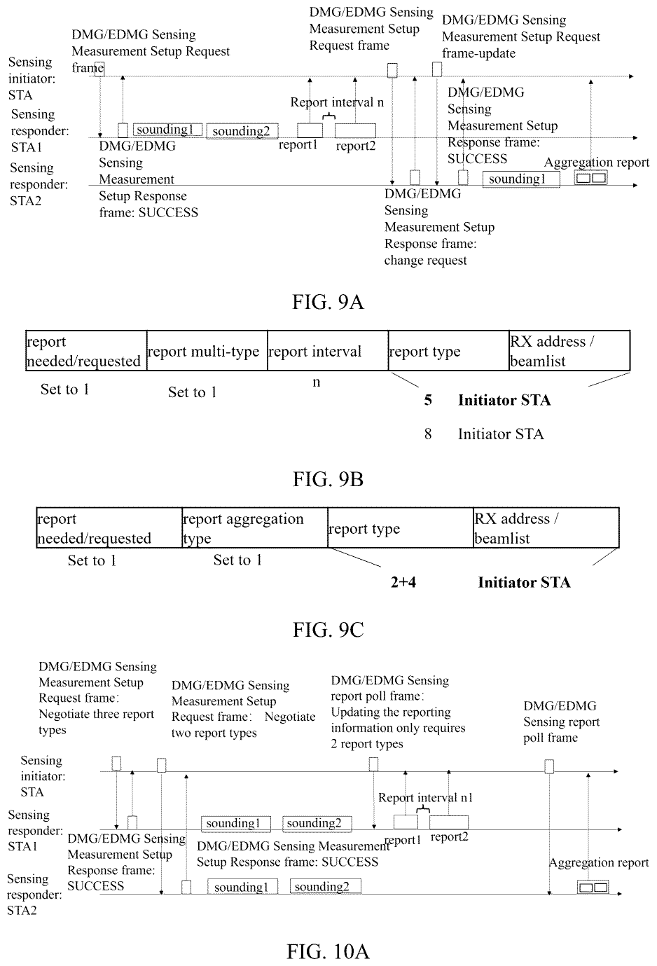

FIG. 9A illustrates an example of a sequential coordinated monostatic DMG/EDMG sensing according to an embodiment of the present disclosure.

FIG. 9A illustrates that, in this embodiment, a scenario of coordinating monostatic DMG/EDMG sensing under sequential mode is shown. Based on the embodiment of the present invention, DMG/EDMG STA as an SI (such as the second STA 20) may first send a DMG/EDMG sensing setup request frame to DMG/EDMG STA1 as an SR (such as the first STA 10). The frame format of the report setup control field in this request frame and the relevant reporting parameters carried are shown in FIG. 9B. According to the report type table as the table 1, index 5 represents “DMG/EDMG Sending Image Doppler-Direction”, and index 8 represents “DMG/EDMG Sending Image Doppler-phase”. After receiving this frame, DMG/EDMG STA1 sends a response frame to SI, which transmits “SUCCESS” information and represents the agreement on all of the sensing parameters. The sensing negotiation stage is completed.

Subsequently, DMG/EDMG STA1 conducted sounding according to the sensing parameter instructions, and there are no polling frames during the reporting stage. Therefore, after the sounding is completed, DMG/EDMG STA1 reports the results of DMG/EDMG Sensing Image Doppler-Direction and DMG/EDMG Sensing Image Doppler-phase using two report frames, and both are reported to SI according to the instructions in report setup control field, with an interval of n between the two reporting frames.

In a sequential way, after receiving the report frame from DMG/EDMG STA1, SI sends a DMG/EDMG sensing setup request frame to DMG/EDMG STA2. DMG/EDMG STA2 sends a response frame to SI after receiving the request frame, providing feedback on “change request information”, indicating that SR has a need to modify a certain parameter or parameters. SI modifies the sensing parameters according to SR's suggested modification values and sends them to SR through a new request frame. The frame format of the report setup control field in this frame and the relevant reporting parameters carried are shown in FIG. 9C. According to the report type table as the table 1, index 2 represents “DMG/EDMG Sensing Image Direction”, and index 4 represents “DMG/EDMG Sensing Image Range-Direction”. SR sends a response frame carrying “SUCCESS” information to SI, and the negotiation stage is completed after SI receives the response frame.

DMG/EDMG STA2 performs sounding and there is no polling during the reporting process, so STA2 reports according to the various reporting parameters transmitted in the report setup control field of the DMG/EDMG sensing setup request frame. The results of DMG/EDMG Sending Image Direction and DMG/EDMG Sending Image Range-Direction are reported through an aggregation frame to SI.

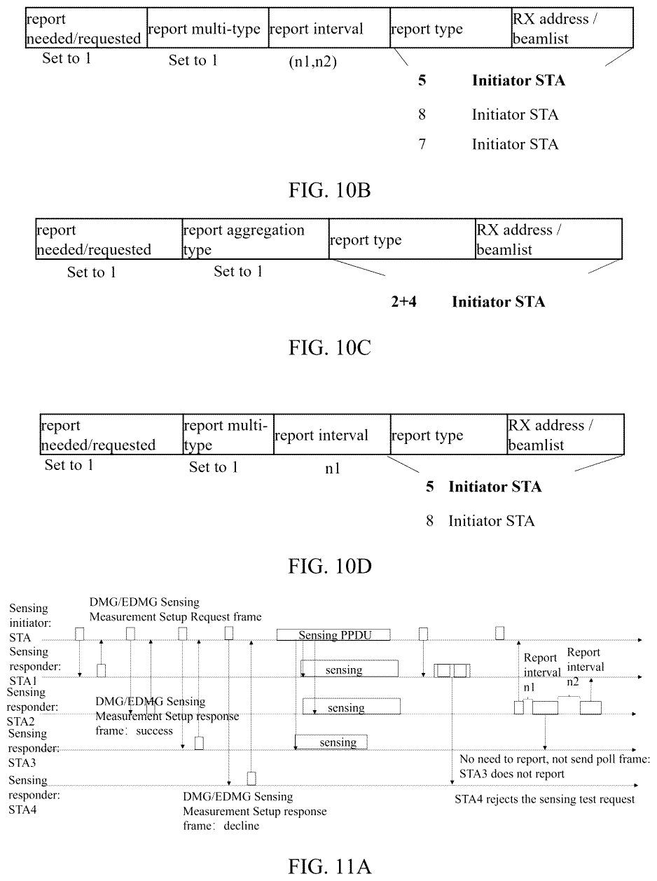

FIG. 10A illustrates an example of a parallel coordinated monostatic DMG/EDMG sensing according to an embodiment of the present disclosure. FIG. 10A illustrates that, in this embodiment, a scenario of coordinating monostatic DMG/EDMG sensing under parallel mode is shown. Based on the embodiment of the present invention, DMG/EDMG STA as SI (such as second STA 20) may send DMG/EDMG sensing setup request frames to DMG/EDMG STA1 and DMG/EDMG STA2 as SRs (such as one or more first STAs 10 and third STAs 30) respectively, as shown in the figure. DMG/EDMG STA1 and STA2 have responded with response frames carrying success information, and SI and SR have completed the negotiation stage respectively. That is, DMG/EDMG STA1 agrees to report three results, and all three reported frames are reported to SI. The reporting intervals for the three reported frames are n1 and n2; DMG/EDMG STA2 agrees to report both results to SI through an aggregated frame. Subsequently, DMG/EDMG STA1 and STA2 can simultaneously perform soundings based on the sensing parameters already negotiated with SI.

The report setup control field in the DMG/EDMG sending setup request frame as illustrated in FIG. 10B is sent by SI to DMG/EDMG STA1.

The report setup control field in the DMG/EDMG sending setup request frame as illustrated in FIG. 10C is sent by SI to DMG/EDMG STA2.

In the reporting stage, SI first sends a report polling frame to DMG/EDMG STA1. In this frame, SI modifies the reporting information, that is, only two types of results need to be reported, and the target results corresponding to index 7 no longer need to be reported. DMG/EDMG STA1 uses two reporting frames to complete the reporting of DMG/EDMG Sending Image Doppler Direction and DMG/EDMG Sending Image Doppler phase, with a reporting interval of n1, according to the instructions of the polling frame. SI sends a report polling frame to DMG/EDMG STA2 without modifying any reporting parameters, so DMG/EDMG STA2 may aggregate the two results in one frame according to the reporting parameters transmitted in the report setup control field of the request frame during the negotiation stage.

The report element field in the report polling frame as illustrated in FIG. 10D is sent by SI to DMG/EDMG STA1.

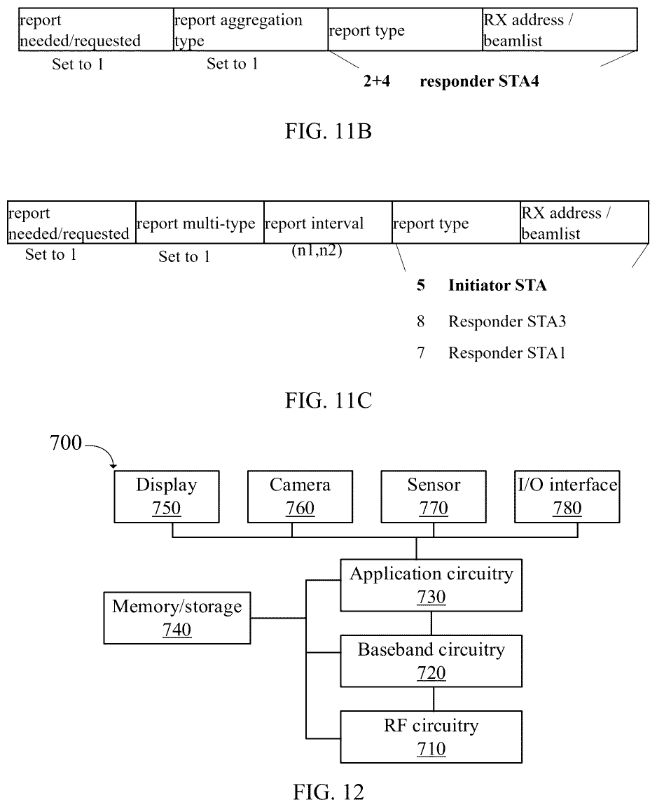

FIG. 11A illustrates an example of a multistatic DMG/EDMG sensing according to an embodiment of the present disclosure. FIG. 11A illustrates that, in this embodiment, a scenario of multistatic DMG/EDMG sensing is shown. Based on the present invention, STA, as an SI (such as second STA 20), may negotiate sensing parameters with each SR (such as one or more first STAs 10 or STAs 30) in its sensing service set. As shown in FIG. 11A, SI sends a DMG/EDMG sending setup request frame to each SR, where DMG/EDMG STA4 sends a response frame carrying ‘DECLINE’ information to SI, indicating that it refuses the sensing task and does not participate in subsequent sensing measurements. The other three SRs provide feedback with ‘SUCCESS’ information through the response frame. During the sounding process, SI sends a physical layer protocol data unit (PPDU) to all SRs, transmitting synchronization and TRN (training) fields through a PPDU. SR may decode some or all of the information used for its own sounding in the PPDU, completing the sensing measurement.

The report setup control field in the DMG/EDMG sending setup request frame as illustrated in FIG. 11B is sent by SI to DMG/EDMG STA1.

The report setup control field in the DMG/EDMG sending setup request frame as illustrated in FIG. 11C is sent by SI to DMG/EDMG STA1.

During the reporting phase, SI may perform polling to each SR separately. Firstly, SI sends a report polling frame to DMG/EDMG STA1. In this frame, it is confirmed that the reporting parameters have not been modified. DMG/EDMG STA1 may aggregate the results, “DMG/EDMG Sensing Image Direction” and “DMG/EDMG Sensing Image Direction”, corresponding to index 2 and 4 in one report frame according to the instructions in the request frame and report them to DMG/EDMG STA4.

Subsequently, SI sends polling frames to DMG/EDMG STA2. DMG/EDMG STA2 reports the results of “DMG/EDMG Sensing Image Doppler-Direction” corresponding to index 5 to SI according to the instructions in the report setup control field, reports the results of “DMG/EDMG Sensing Image Doppler-phase” corresponding to index 8 to DMG/EDMG STA3 after the reporting interval n1, and reports the results of “Target” corresponding to index 7 to DMG/EDMG STA1 after the reporting interval n2. SI does not send a polling frame to DMG/EDMG STA3, indicating that SI no longer needs DMG/EDMG STA3 to report any results, so DMG/EDMG STA3 may not perform any result reporting without receiving the polling frame.

The scenarios of the embodiments are described in detail as follows.

### EMBODIMENTS

### Sequential Coordinated Monostatic DMG/EDMG Sensing

FIG. 9A illustrates that, in this embodiment, a scenario of coordinating monostatic DMG/EDMG sensing under sequential mode is shown. Based on the embodiment of the present invention, DMG/EDMG STA as an SI (such as the second STA 20) may first send a DMG/EDMG sensing setup request frame to DMG/EDMG STA1 as an SR (such as the first STA 10). The frame format of the report setup control field in this request frame and the relevant reporting parameters carried are shown in FIG. 9B. According to the report type table as the table 1, index 5 represents “DMG/EDMG Sending Image Doppler-Direction”, and index 8 represents “DMG/EDMG Sending Image Doppler-phase”. After receiving this frame, DMG/EDMG STA1 sends a response frame to SI, which transmits “SUCCESS” information and represents the agreement on all of the sensing parameters. The sensing negotiation stage is completed.

Subsequently, DMG/EDMG STA1 conducted sounding according to the sensing parameter instructions, and there are no polling frames during the reporting stage. Therefore, after the sounding is completed, DMG/EDMG STA1 reports the results of DMG/EDMG Sensing Image Doppler-Direction and DMG/EDMG Sensing Image Doppler-phase using two report frames, and both are reported to SI according to the instructions in report setup control field, with an interval of n between the two reporting frames.

In a sequential way, after receiving the report frame from DMG/EDMG STA1, SI sends a DMG/EDMG sensing setup request frame to DMG/EDMG STA2. DMG/EDMG STA2 sends a response frame to SI after receiving the request frame, providing feedback on “change request information”, indicating that SR has a need to modify a certain parameter or parameters. SI modifies the sensing parameters according to SR's suggested modification values and sends them to SR through a new request frame. The frame format of the report setup control field in this frame and the relevant reporting parameters carried are shown in FIG. 9C. According to the report type table as the table 1, index 2 represents “DMG/EDMG Sensing Image Direction”, and index 4 represents “DMG/EDMG Sensing Image Range-Direction”. SR sends a response frame carrying “SUCCESS” information to SI, and the negotiation stage is completed after SI receives the response frame.

DMG/EDMG STA2 performs sounding and there is no polling during the reporting process, so STA2 reports according to the various reporting parameters transmitted in the report setup control field of the DMG/EDMG sensing setup request frame. The results of DMG/EDMG Sending Image Direction and DMG/EDMG Sending Image Range-Direction are reported through an aggregation frame to SI.

### Parallel Coordinated Monostatic DMG/EDMG Sensing

FIG. 10A illustrates that, in this embodiment, a scenario of coordinating monostatic DMG/EDMG sensing under parallel mode is shown. Based on the embodiment of the present invention, DMG/EDMG STA as SI (such as second STA 20) may send DMG/EDMG sensing setup request frames to DMG/EDMG STA1 and DMG/EDMG STA2 as SRs (such as one or more first STAs 10 and third STAs 30) respectively, as shown in the figure. DMG/EDMG STA1 and STA2 have responded with response frames carrying success information, and SI and SR have completed the negotiation stage respectively. That is, DMG/EDMG STA1 agrees to report three results, and all three reported frames are reported to SI. The reporting intervals for the three reported frames are n1 and n2; DMG/EDMG STA2 agrees to report both results to SI through an aggregated frame. Subsequently, DMG/EDMG STA1 and STA2 can simultaneously perform soundings based on the sensing parameters already negotiated with SI.

The report setup control field in the DMG/EDMG sending setup request frame as illustrated in FIG. 10B is sent by SI to DMG/EDMG STA1.

The report setup control field in the DMG/EDMG sending setup request frame as illustrated in FIG. 10C is sent by SI to DMG/EDMG STA2.

In the reporting stage, SI first sends a report polling frame to DMG/EDMG STA1. In this frame, SI modifies the reporting information, that is, only two types of results need to be reported, and the target results corresponding to index 7 no longer need to be reported. DMG/EDMG STA1 uses two reporting frames to complete the reporting of DMG/EDMG Sending Image Doppler Direction and DMG/EDMG Sending Image Doppler phase, with a reporting interval of n1, according to the instructions of the polling frame. SI sends a report polling frame to DMG/EDMG STA2 without modifying any reporting parameters, so DMG/EDMG STA2 may aggregate the two results in one frame according to the reporting parameters transmitted in the report setup control field of the request frame during the negotiation stage.

The report element field in the report polling frame as illustrated in FIG. 10D is sent by SI to DMG/EDMG STA1.

### Multistatic DMG/EDMG Sensing

FIG. 11A illustrates that, in this embodiment, a scenario of multistatic DMG/EDMG sensing is shown. Based on the present invention, STA, as an SI (such as second STA 20), may negotiate sensing parameters with each SR (such as one or more first STAs 10 or STAs 30) in its sensing service set. As shown in FIG. 11A, SI sends a DMG/EDMG sending setup request frame to each SR, where DMG/EDMG STA4 sends a response frame carrying ‘DECLINE’ information to SI, indicating that it refuses the sensing task and does not participate in subsequent sensing measurements. The other three SRs provide feedback with ‘SUCCESS’ information through the response frame. During the sounding process, SI sends a physical layer protocol data unit (PPDU) to all SRs, transmitting synchronization and TRN (training) fields through a PPDU. SR may decode some or all of the information used for its own sounding in the PPDU, completing the sensing measurement.

The report setup control field in the DMG/EDMG sending setup request frame as illustrated in FIG. 11B is sent by SI to DMG/EDMG STA1.

The report setup control field in the DMG/EDMG sending setup request frame as illustrated in FIG. 11C is sent by SI to DMG/EDMG STA1.

During the reporting phase, SI may perform polling to each SR separately. Firstly, SI sends a report polling frame to DMG/EDMG STA1. In this frame, it is confirmed that the reporting parameters have not been modified. DMG/EDMG STA1 may aggregate the results, “DMG/EDMG Sensing Image Direction” and “DMG/EDMG Sensing Image Direction”, corresponding to index 2 and 4 in one report frame according to the instructions in the request frame and report them to DMG/EDMG STA4.

Subsequently, SI sends polling frames to DMG/EDMG STA2. DMG/EDMG STA2 reports the results of “DMG/EDMG Sensing Image Doppler-Direction” corresponding to index 5 to SI according to the instructions in the report setup control field, reports the results of “DMG/EDMG Sensing Image Doppler-phase” corresponding to index 8 to DMG/EDMG STA3 after the reporting interval n1, and reports the results of “Target” corresponding to index 7 to DMG/EDMG STA1 after the reporting interval n2.

SI does not send a polling frame to DMG/EDMG STA3, indicating that SI no longer needs DMG/EDMG STA3 to report any results, so DMG/EDMG STA3 may not perform any result reporting without receiving the polling frame.

FIG. 12 is a block diagram of an example system 700 for wireless communication according to an embodiment of the present disclosure. Embodiments described herein may be implemented into the system using any suitably configured hardware and/or software. FIG. 21 illustrates the system 700 including a radio frequency (RF) circuitry 710, a baseband circuitry 720, an application circuitry 730, a memory/storage 740, a display 750, a camera 760, a sensor 770, and an input/output (I/O) interface 780, coupled with each other at least as illustrated. The application circuitry 730 may include a circuitry such as, but not limited to, one or more single-core or multi-core processors. The processors may include any combination of general-purpose processors and dedicated processors, such as graphics processors, application processors. The processors may be coupled with the memory/storage and configured to execute instructions stored in the memory/storage to enable various applications and/or operating systems running on the system.

While the present disclosure has been described in connection with what is considered the most practical and preferred embodiments, it is understood that the present disclosure is not limited to the disclosed embodiments but is intended to cover various arrangements made without departing from the scope of the broadest interpretation of the appended claims.

1. A wireless local area network (WLAN) sensing method by a WLAN system, wherein the WLAM system comprises one or more first stations (STAs), a second STA, and/or one or more third STAs, and the WLAN sensing method comprises:
reporting, by the one or more first STAs, multiple types of measurement results to the second STA and/or the one or more third STAs through one measurement setup, wherein the measurement results and the measurement setup are associated with a directional multi gigabit (DMG)/enhanced DMG (EDMG) sensing.

2. The WLAN sensing method according to claim 1, wherein reporting, by the one or more first STAs, the types of the measurement results to the second STA and/or the one or more third STAs through the measurement setup is based on multiple sensing task requirements.

3. The WLAN sensing method according to claim 1, further comprising determining, by the one or more first STAs, a real-time update, a verification of a reporting type, and/or an addressing of the measurement setup and/or the measurement results through a report polling frame.

4. The WLAN sensing method according to claim 1, wherein reporting, by the one or more first STAs, the types of the measurement results to the second STA and/or the one or more third STAs through the measurement setup further comprises at least one of the following operations:
a DMG/EDMG sensing negotiation;
one or more DMG/EDMG measurement bursts;
one or more DMG/EDMG measurement reports; and/or
a DMG/EDMG sensing termination.

5. The WLAN sensing method according to claim 4, wherein the DMG/EDMG sensing negotiation further comprises the one or more first STAs receiving a sensing measurement setup request frame form the second STA.

6. The WLAN sensing method according to claim 4, wherein the DMG/EDMG sensing negotiation further comprises the one or more first STAs transmitting a sensing measurement setup response frame to the second STA to response to the sensing measurement setup request frame.

7. The WLAN sensing method according to claim 5, wherein the sensing measurement setup request frame comprises a report setup control field containing sensing setup parameters related to the measurement report.

8. The WLAN sensing method according to claim 7, wherein the sensing setup parameters related to the measurement report comprise a reporting type, a receiver (RX) address/beamlist, and/or an interval parameter.

9. The WLAN sensing method according to claim 6, wherein the one or more first STAs response a success feedback information through the sensing measurement setup response frame, and the success feedback information indicates that sensing setup parameters from the second STA are accepted by the one or more first STAs, and when the DMG/EDMG sensing negotiation is completed, the one or more first STAs start measuring.

10. The WLAN sensing method according to claim 6, wherein the one or more first STAs response a suggested change feedback information through the sensing measurement setup response frame, and the suggested change feedback information indicates that the one or more first STAs provide modification values for the sensing setup parameters.

11. The WLAN sensing method according to claim 10, wherein the sensing setup parameters are updated by the second STA based on the modification values, and/or the one or more first STAs are configured to receive an updated sensing measurement setup request frame comprising updated sensing setup parameters based on the modification values.

12. The WLAN sensing method according to claim 11, wherein the one or more first STAs are configured to transmit an updated sensing measurement setup response frame to the second STA, the updated sensing measurement setup response frame comprises a success feedback information, and the success feedback information indicates that the updated sensing setup parameters from the second STA are accepted by the one or more first STAs, and when the DMG/EDMG sensing negotiation is completed, the one or more first STAs start measuring.

13. The WLAN sensing method according to claim 6, wherein the one or more first STAs respond a decline feedback information through the sensing measurement setup response frame, and the decline feedback information indicates that the one or more first STAs refuse to negotiate a current sensing setup and/or has no participation in a current sensing task.

14. The WLAN sensing method according to claim 4, wherein in the one or more DMG/EDMG measurement bursts, the one or more first STAs are configured to perform sounding based on sensing setup parameters.

15. The WLAN sensing method according to claim 14, wherein after the one or more first STAs perform sounding, the one or more first STAs transmit the DMG/EDMG measurement report comprising the multiple types of measurement results to the second STA and/or the one or more third STAs.

16. The WLAN sensing method according to claim 15, wherein the one or more first STAs transmitting the DMG/EDMG measurement report to the second STA and/or the one or more third STAs comprise that:
the one or more first STAs are configured to receive a report polling frame from the second STA, and the one or more first STAs are configured to transmit a report frame comprising the multiple types of measurement results to the second STA and/or the one or more third STAs; or
the one or more first STAs are configured to transmit the report frame comprising the multiple types of measurement results to the second STA and/or the one or more third STAs.

17. The WLAN sensing method according to claim 4, wherein the DMG/EDMG sensing termination comprises that:
a DMG/EDMG sensing termination frame are transmitted by the one or more first STAs, the second STA, and/or the one or more third STAs to terminate sensing;
in the DMG/EDMG sensing negotiation, an agreement is made by the one or more first STAs, the second STA, and/or the one or more third STAs, and the agreement agrees to terminate sensing by default after the one or more first STAs send the report frame for a period of time; or
the one or more first STAs fail to complete the DMG/EDMG measurement report after a certain period of time, and/or a sensing process is timed out and terminated.

18. The WLAN sensing method according to claim 5, wherein the report setup control field of the sensing measurement setup request frame comprises a report requested/needed subfield and none or at least one of a report multi-type subfield, a report type subfield, an RX address/beamlist subfield, and a report interval subfield, and the report requested/needed subfield indicates whether the one or more first STAs need to report the measurement results to the second STA and/or the one or more third STAs.

19. The WLAN sensing method according to claim 18, wherein if the report requested/needed subfield comprises a first value, the first value of the report requested/needed subfield indicates that reporting DMG/EDMG measurement results to the second STA and/or the one or more third STAs are required, and the report multi-type subfield is a mandatory subfield.

20-38. (canceled)

39. A WLAN system, comprising:
one or more first STAs, a second STA, and/or one or more third STAs, wherein the one or more first STAs are configured to report multiple types of measurement results to the second STA and/or the one or more third STAs through one measurement setup, wherein the measurement results and the measurement setup are associated with a directional multi gigabit (DMG)/enhanced DMG (EDMG) sensing.
